(19) United States
(12) Patent Application Publication
(10) Pub. No.: US 2026/0244907 A1
(43) Pub. Date: Aug. 20, 2026

(54) METHOD AND DEVICE FOR DEEP LEARNING NETWORK ENCODING/DECODING USING STANDARD NORMAL DISTRIBUTION-BASED QUANTIZATION TECHNIQUE

(71) Applicant: Korea Electronics Technology Institute, Seongnam-si (KR)

(72) Inventors: Sung Jei KIM, Seoul (KR); Jin Woo JEONG, Seoul (KR); Kyu Heon KIM, Seoul (KR); Seong Bae RHEE, Yongin-si (KR); Min Seok LEE, Suwon-si (KR)

(73) Assignee: Korea Electronics Technology Institute, Seongnam-si (KR)

(21) Appl. No.: 19/099,284

(22) PCT Filed: Jul. 28, 2023
(86) PCT No.: PCT/KR2023/011047

§ 371 Date: Jan. 28, 2025

(30) Foreign Application Priority Data
Jul. 28, 2022 (KR) 10-2022-0093959

(51) Int. Cl. G06N 3/0495

(52) U.S. Cl. CPC G06N 3/0495

(57) ABSTRACT

Disclosed herein are a method and apparatus for encoding/decoding a deep learning network. According to an embodiment, the method for encoding a deep learning network by using a quantization scheme based on a standard normal distribution may include quantizing a residual parameter and performing entropy encoding on the quantized residual parameter, wherein the quantizing of the residual parameter determines a degree of importance of the residual parameter based on a predefined threshold by using the standard normal distribution and then selectively applies any one or more of a plurality of quantization schemes based on the determined degree of importance.

### TECHNICAL FIELD

The present disclosure relates to an encoding or decoding method and apparatus for a deep learning network, and particularly, to a deep learning network encoding or decoding method and apparatus using a quantization scheme based on a standard normal distribution for encoding or decoding residual information or a residual parameter.

### BACKGROUND

With the recent advances in storage devices and computation devices, artificial intelligence (AI) systems are advancing rapidly. In particular as a technology for implementing such AIs, deep learning is being actively studied. Especially, as the capacity of a deep learning network dramatically increases on account of the advancements in storage and computation devices, data transmission faces many difficulties recently.

Accordingly, the Compression of Neural Network for Multimedia Content Description and Analysis (NCC), which is a standard of ISO/IEC-affiliated JTC1/SC29/WG4, has proposed a method for making a deep learning network lightweight through parameter reduction and then compressing the network by parameter quantization and entropy coding. The NCC standard relates to the standardization of compression of such a pre-trained deep learning network, and the compression of residual information generated by federated learning is currently under discussion.

### DETAILED DESCRIPTION OF THE INVENTION

### Technical Problem

The present disclosure is directed to providing a method and apparatus for encoding/decoding a deep learning network.

Also, the present disclosure is directed to providing a method and apparatus for efficiently quantizing residual information generated by federated learning of a deep learning network.

Also, the present disclosure is directed to providing a method and apparatus for making a pre-trained deep learning network lightweight through compression of parameters like weights of the deep learning network in an artificial intelligence (AI) system using the deep learning network and an application thereof.

Other objects and advantages of the present disclosure may be understood through the following description and be known more clearly by the embodiments of the present disclosure. In addition, it may be easily understood that the objects and advantages of the present disclosure can be implemented by the means described in the appended claims and a combination thereof.

### Means for Solving the Problem

According to the present disclosure, a method for encoding a deep learning network by using a quantization scheme based on a standard normal distribution, the method may comprising: quantizing a residual parameter; and performing entropy encoding on the quantized residual parameter, wherein the quantizing of the residual parameter determines a degree of importance of the residual parameter based on a predefined threshold by using the standard normal distribution and then selectively applies any one or more of a plurality of quantization schemes based on the determined degree of importance.

According to the embodiment of the present disclosure in the method, wherein the quantizing of the residual parameter comprises: determining a binary flag for selecting a quantization scheme by using a mean and a standard deviation of the residual parameter, transforming the residual parameter into a standard normal distribution and determining the degree of importance of the residual parameter from the standard normal distribution and quantizing the residual parameter by applying any one of a pruning quantization scheme, a binary quantization scheme, a ternary quantization scheme or an additive exponent quantization scheme, or a combination thereof and by using the determined degree of importance and the binary flag.

According to the embodiment of the present disclosure, wherein the residual parameter is a residual weight of the deep learning network, which is generated by federated learning.

According to the embodiment of the present disclosure, wherein the quantizing of the residual parameter further comprises flattening a dimension of a residual parameter to be quantized, and wherein a changed dimension of the residual parameter is derived as one dimension.

According to the embodiment of the present disclosure, wherein the pruning quantization scheme is selected when an absolute of a value (z) normalized by the standard normal distribution is smaller than a preset first threshold.

According to the embodiment of the present disclosure, wherein the preset first threshold is 1.

According to the embodiment of the present disclosure, wherein the pruning quantization scheme replaces every residual parameter, to which the pruning quantization scheme is applied, by 0.

According to the embodiment of the present disclosure, wherein any one of the binary quantization scheme or the ternary quantization scheme is selected when the absolute value of the value (z) normalized by the standard normal distribution is within a specific preset interval.

According to the embodiment of the present disclosure, wherein the specific preset interval is an interval between 1 and 2.

According to the embodiment of the present disclosure, wherein the quantizing of the residual parameter further comprises calculating a probability density function for each layer of the deep learning network, wherein the binary flag for selecting one from the binary quantization or the ternary quantization scheme is determined by obtaining a mean and a standard deviation from a normal distribution of the probability density function.

According to the embodiment of the present disclosure, wherein, when a difference between the mean and the standard deviation of the residual parameter has an absolute value greater than 0, the binary flag is set to true and the binary quantization scheme is selected.

According to the embodiment of the present disclosure, wherein, when the difference between the mean and the standard deviation of the residual parameter has an absolute value smaller than 0, the binary flag is set to false and the ternary quantization scheme is selected.

According to the embodiment of the present disclosure, wherein the additive exponent quantization scheme is selected when the absolute of the value (z) normalized by the standard normal distribution is greater than a preset second threshold. According to the embodiment of the present disclosure, wherein the preset second threshold is 2.

According to the present disclosure, a method for decoding a deep learning network that is encoded by a quantization scheme based on a standard normal distribution, the method may comprising: performing entropy decoding to obtain a residual parameter to be dequantized and quantization information and performing inverse-quantization to dequantize the residual parameter, wherein the performing of the inverse-quantization comprises deriving a quantization scheme applied to an encoded residual parameter among a plurality of quantization schemes from the obtained quantization information and deriving a restored residual parameter by applying an inverse-quantization scheme corresponding to the derived quantization scheme.

According to the embodiment of the present disclosure, the plurality of quantization schemes include a pruning quantization scheme, a binary quantization scheme, a ternary quantization scheme, and an additive exponent quantization scheme.

According to the present disclosure, a method for encoding a deep learning network performing federated learning through a plurality of clients, the method may comprising: generating residual information, which is a difference value of a baseline model, from an updated model that is additionally trained by the clients and quantizing the residual information, wherein the quantizing of the residual information determines a degree of importance of the residual information based on a predefined threshold by using a standard normal distribution and then selectively applies any one or more of a plurality of quantization schemes based on the determined degree of importance.

According to another present disclosure, there is provided a system for performing federated learning, the deep learning network system may comprising: a plurality of clients configured to generate residual information, which is a difference value of a baseline model, from an updated model that is additionally trained, and a central server configured to receive the generated residual information from the plurality of clients and to generate and transmit enhanced residual information to the plurality of clients, wherein the residual information generated by the plurality of clients or the enhanced residual information generated by the central server is quantized by determining a degree of importance based on a predefined threshold using a standard normal distribution and then by selectively applying any one or more of a plurality of quantization schemes based on the determined degree of importance.

According to the present disclosure, a method for encoding a deep learning network, the quantization method comprising: determining a binary flag for selecting a quantization scheme by using a mean and a standard deviation of residual information to be quantized, transforming the residual information into a standard normal distribution and determining a degree of importance of the residual importance from the standard normal distribution and quantizing the residual importance by applying any one of a pruning quantization scheme, a binary quantization scheme, a ternary quantization scheme or an additive exponent quantization scheme, or a combination thereof and by using the determined degree of importance and the binary flag.

According to the present disclosure, a method for decoding a deep learning network, the inverse-quantization, the method may comprising: obtaining quantization information for encoded residual information deriving, from the quantization information, a quantization scheme applied to the encoded residual information among a binary quantization scheme, a ternary quantization scheme, or an additive exponent quantization scheme.

The method further comprise deriving restored residual information by applying an inverse-quantization scheme corresponding to the derived quantization scheme.

### Effects of the Invention

According to various embodiments of the present disclosure, in encoding and decoding a deep learning network, it is possible to efficiently compress residual information of the deep learning network occurring during federated learning by applying a quantization scheme based on a standard normal distribution to the residual information. Specifically, by setting an efficient threshold in a standard normal distribution, data loss can be minimized because a weight deemed to be of high importance is maintained as long as possible. Specifically, according to various embodiments of the present disclosure, it is possible to solve the problem of significant data loss in the related art by quantizing positive and negative data excluding 0 in a data set into mean values. In addition, according to various embodiments of the present disclosure, when residual information generated by federated learning is to be efficiently transmitted from a central server to various devices, a quantization scheme can be utilized to ensure a high compression rate and low performance degradation.

### BRIEF DESCRIPTION OF THE DRAWINGS

FIG. 1 is a view for describing a parameter occurring in a deep learning network, as an example of a fully connected layer of the deep learning network according to an embodiment of the present disclosure.

FIG. 2 is a view describing an example of a service model for federated learning according to an embodiment of the present disclosure.

FIG. 3 is a view for describing a process in which residual information is generated during federated learning, as handled by the Compression of Neural Network for Multimedia Content Description and Analysis (NNC) standard, according to an embodiment of the present disclosure.

FIG. 4 is a view for describing a general trend of residual information occurring during federated learning according to an embodiment of the present disclosure.

FIG. 5 illustrates an NNC encoding and decoding apparatus for describing a compression process in the NNC standard according to an embodiment of the present disclosure.

FIG. 6 is a view for describing a process of a quantization scheme based on a standard normal distribution for a residual weight in federated learning according to an embodiment of the present disclosure.

FIG. 7 is a view for describing a dimension flattening process according to an embodiment of the present disclosure.

FIG. 8 is a view for describing a normal distribution according to an embodiment of the present disclosure.

FIG. 9 is a view for visually showing a criterion for determining truth/false of binary_flag according to an embodiment of the present disclosure.

FIG. 10 is a view for describing a process of determining whether binary_flag is true or false, according to an embodiment of the present disclosure.

FIG. 11 is a view for describing a standard normal distribution according to an embodiment of the present disclosure.

FIG. 12 is a view for describing pruning quantization according to an embodiment of the present disclosure.

FIG. 13 is a view for describing binary-ternary quantization according to an embodiment of the present disclosure.

FIG. 14 is a view for describing additive exponent quantization according to an embodiment of the present disclosure.

FIG. 15 is a view illustrating a specific example of additive exponent quantization according to an embodiment of the present disclosure.

FIG. 16 and FIG. 17 illustrate a method for encoding a deep learning network by using a quantization scheme based on a standard normal distribution according to an embodiment of the present disclosure.

FIG. 18 and FIG. 19 illustrate a method for decoding a deep learning network encoded by a quantization scheme based on a standard normal distribution according to an embodiment of the present disclosure.

FIG. 20 illustrates a deep learning network encoding method that performs federated learning through a plurality of clients according to an embodiment of the present disclosure.

FIG. 21 illustrates a quantization method for encoding a deep learning network according to an embodiment of the present disclosure.

FIG. 22 illustrates an inverse-quantization method for decoding a deep learning network according to an embodiment of the present disclosure.

FIG. 23 illustrates an example of a content streaming system to which an embodiment according to the present disclosure is applicable.

### DESCRIPTION OF THE PREFERRED EMBODIMENTS

The present disclosure may be subject to various modifications and have various embodiments. Specific embodiments of the present disclosure will be described in detail with reference to the accompanying drawings. However, the embodiments are not intended to limit the technical scope of the present disclosure, and it is to be understood that the present disclosure covers various modifications, equivalents, and alternatives within the scope and idea of the present disclosure. In the drawings, the similar reference numerals refer to the same or similar functions in various aspects. In the drawings, the shapes and dimensions of elements may be exaggerated for clarity. In the following detailed description of the present disclosure, references are made to the accompanying drawings that show, by way of illustration, specific embodiments. These embodiments are described in sufficient detail to enable those skilled in the art to implement them. It should be understood that various embodiments of the present disclosure, although different, are not necessarily mutually exclusive. For example, specific features, structures, and characteristics described herein may be implemented within other embodiments without departing from the spirit and scope of the present disclosure. In addition, it should be understood that the location or arrangement of individual elements within each disclosed embodiment may be modified without departing from the spirit and scope of the present disclosure. The following detailed description is, therefore, not to be taken in a limiting sense, and the scope of exemplary embodiments is defined only by the appended claims, appropriately interpreted, along with the full range of equivalents to what the claims claim.

The terms as used in the disclosure, first and second may be used to describe various components, not limiting the components. These expressions are used only to distinguish one component from another component. For example, a first component may be referred to as a second component and vice versa without departing from the scope of the present disclosure. The term and/or covers a combination of a plurality of related items or any one of the plurality of related items.

When it is said in the present disclosure that a component is “connected to” or “coupled with/to” another component, it should be understood that the one component is connected to the other component directly or through any other component. On the other hand, when it is said that a component is “directly connected to” or “directly coupled to” another component, it should be understood that there is no other component between the components.

Constitutional parts shown in the embodiments of the present disclosure are independently shown so as to represent characteristic functions different from each other. Thus, it does not mean that each constitutional part is constituted in a constitutional unit of separated hardware or software. In other words, respective constitutional parts are enumerated and included as each constitutional part for convenience of description. Thus, at least two constitutional parts may be combined to form one constitutional part or one constitutional part may be divided into a plurality of constitutional parts to perform a function. An embodiment combining or separating such constitutional parts is also included in the scope of the present disclosure, if not departing from the essence of the present disclosure.

The terms as used in the present disclosure are provided to describe merely specific embodiments, not intended to limit the present disclosure. Singular forms include plural referents unless the context clearly dictates otherwise. In the present disclosure, the term “include” or “have” signifies the presence of a feature, a number, a step, an operation, a component, a part, or a combination thereof, not excluding the presence or addition of one or more other features, numbers, steps, operations, components, parts, or a combination thereof. That is, in the present disclosure, when a description “includes” a specific configuration, it means that other configurations than the specific configuration are not excluded but an additional configuration may be included in the scope of implementation of the present disclosure or in the technical idea of the present disclosure.

Some constitutional elements of the present disclosure are not necessary constitutional elements for performing essential functions of the present disclosure but may be optional constitutional elements merely for improving performance. The present disclosure may be implemented by including only necessary constitutional parts, while excluding constitutional parts used merely for improving performance, and a structure including only necessary constitutional elements but not optional constitutional elements used merely for improving performance is also included in the scope of rights of the present disclosure.

Hereinafter, embodiments of the present disclosure will be described in detail with reference to the accompanying drawings such that those skilled in the art may easily implement the embodiments. In addition, when describing embodiments of the present specification, if a detailed description of a relevant known configuration or function is deemed to blur the essence of the present disclosure, the detailed description will be omitted. In the drawings, same reference numerals will be used for same constitutional elements, and a repeated description about an identical constitutional element will be omitted.

In this regard, an embodiment described in the present disclosure compresses residual information generated by federated learning by applying a new quantization scheme, and a technique for implementing such an embodiment will be described in detail below.

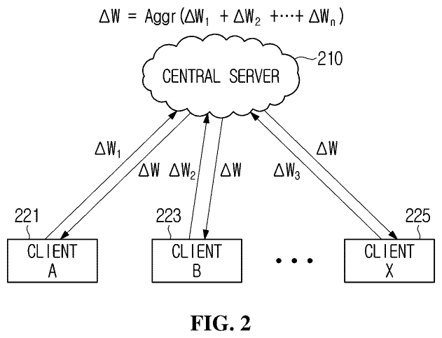

First of all, ‘federated learning’ mentioned in the present disclosure may mean a method by which a central server distributes a baseline model to various devices to enable each of the device to learn the baseline model and then collects residual information between an updated model and the baseline model to create and redistribute a further reinforced model. This will be described in detail with reference to FIG. 2, and the present disclosure proposes modification and adjustment of a basic module presented by the NNC standard in consideration of the characteristics of residual information from federated learning, while adhering to the concept of the NNC standard module that has been proposed to compress residual information occurring during a federated learning process.

In addition, ‘residual information’ mentioned in the present disclosure means every information related to residuals including the above-described residual parameter. Herein, the residual parameter may include a residual weight. Hereinafter, for more accurate understanding, the terms ‘residual information’, ‘residual parameter’ and ‘residual weight’ will be used interchangeably in the following description of the present disclosure.

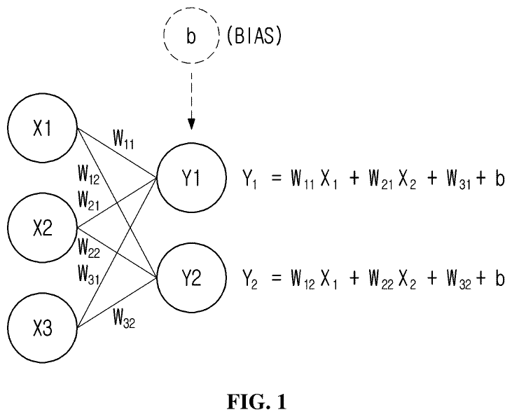

FIG. 1 is a view for describing a parameter occurring in a deep learning network, as an example of a fully connected layer of the deep learning network according to an embodiment of the present disclosure.

Generally, a deep learning network consists of numerous layers, and as illustrates in FIG. 1, each layer consists of neurons corresponding to x1~x3 and y1~y2, weights W11~W32 and a bias corresponding to b. On the other hand, FIG. 1 is a conceptual diagram that is simplified for convenience of explanation, and layers used in a real deep learning model usually consist of numerous neurons and weights and thus contain an massive amount of data. A neuron is a value calculated with a weight, and the term ‘pre-trained model’ may generally mean a weight and a bias that are determined through training. In particular, information on the weight and the bias may be stored in a different scheme depending on a deep learning framework, and for example, a general-purpose framework may be PyTorch or TensorFlow.

FIG. 2 is a view describing an example of a service model for federated learning according to an embodiment of the present disclosure. The service model shown in FIG. 2 conceptually illustrates a scenario of typical federated learning for convenience of explanation. For example, when a central server 210 distributes a baseline model to each of clients 221, 223 and 225, each client trains the baseline model by using its own data. Next, each of the clients 221, 223 and 225 sends residual information, which is a difference value between a trained updated model and the baseline model, back to the central server 210. Herein, the residual information corresponds to ΔWᵢ~ΔWₙ of FIG. 2. Next, the central server 210 enhances the baseline model based on the collected residual information and distributes enhanced residual information, which is a difference value between the enhanced model and the existing baseline model, to each client again. Herein, the enhanced residual information corresponds to ΔW of FIG. 2. The process is performed at each epoch. In this regard, the federated learning method does not send data of the clients 221, 223 and 225 straight to the central server 210 and thus prevents leak of personal information.

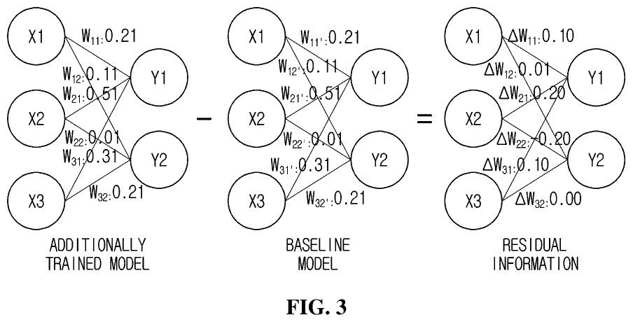

FIG. 3 is a view for describing a process in which residual information is generated during federated learning, as discussed in the NNC standard, according to an embodiment of the present disclosure. As illustrated in FIG. 3, residual information means a difference value between a parameter of a further trained model and a parameter of a baseline model. That is, residual information represented by ΔW₁₁~ΔW₃₂ of FIG. 3 is a value obtained by subtracting W′₁₁~W′₃₂ from W₁₁~W₃₂. When there is also a difference of bias, such a difference is stored, but residual information of bias is generally 0. That is, two models generating residual information should have an identical form, and residual information has a same dimension as the two models. Generally, in federated learning, re-training at each epoch does not significantly affect a weight of a model. Accordingly, enhanced models at each epoch have similar parameters. Accordingly, residual information, which is a difference value between models at each epoch, has a high percentage of 0, and values close to 0 also have values very close to 0. Ultimately, this means that a method for compressing such residual information should be different from an existing technique of compressing a weight of a trained model.

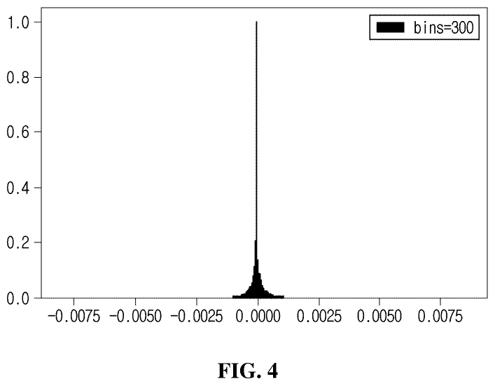

FIG. 4 is a view for describing a general trend of residual information occurring during federated learning according to an embodiment of the present disclosure. As described above, residual information mostly consists of 0 or a value close to 0. This is visually illustrated in the histogram of FIG. 4, which is a result derived through real data values for the federated learning scenario of FIG. 2. Referring to the histogram of FIG. 4, the percentage of 0 is highest, and the frequency decreases sequentially as it moves further away from 0. That is, it may be known from FIG. 4 that residual information data generated by federated learning has a form of normal distribution.

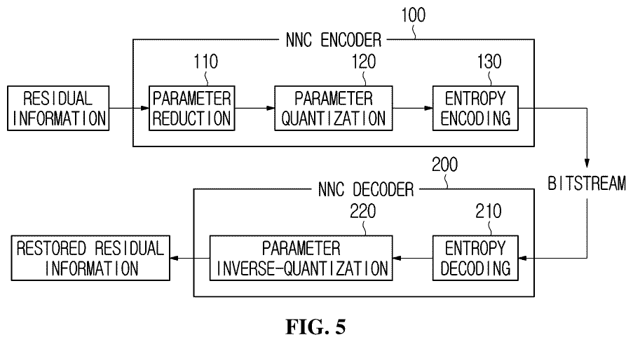

FIG. 5 illustrates a configuration of an NNC encoding and decoding apparatus for describing a compression process in the NNC standard according to the present disclosure. As illustrated in FIG. 5, an NNC encoding apparatus may be configured by including 3 basic modules. That is, the NNC encoding apparatus includes a parameter reduction module 110, a parameter quantization module 120, and an entropy coding module 130.

Specifically, the parameter reduction module 110 is a step for making a network lightweight and may include, most of all, a sparsification process and a pruning process. For example, sparsification for a pre-trained model means retraining for model weights to increase a percentage of values close to 0, and it means discriminating importance of weights and making a value of low importance zero through the parameter reduction. Herein, the importance may means a degree to which a parameter affects a deep learning network, and a value closer to 0 means lower importance. However, for residual information in federated learning, not a weight of a trained model, parameter reduction is hardly used because retraining is difficult to perform for residual information.

The parameter quantization module 120 performs parameter quantization on information (e.g., residual information) that has undergone the parameter reduction. For example, scalar quantization, codebook quantization, and stochastic binary-ternary (STB) quantization may be representative methods of quantizing a weight of a trained model. In particular, when the above-described residual information is quantized, the SBT quantization is mostly used.

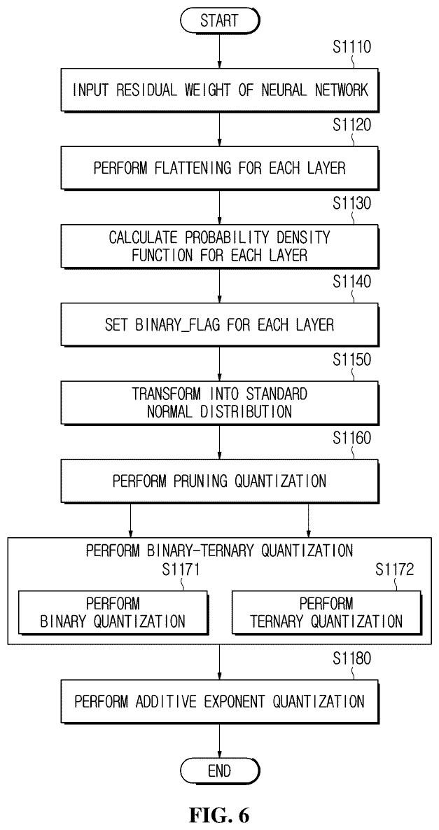

Herein, the SBT quantization of the parameter quantization model is a scheme of randomly selecting binary or ternary quantization based on a probability. The SBT quantization is directed to enhancing compression efficiency by quantizing positive and negative data excluding zero (0) in a data set into a mean value. However, because data values excluding 0 cause data loss that is too significant to be replaced by a mean value, a deep learning network, to which corresponding compression is applied, has a limitation that performance degradation may occur. For example, generally, the feature of residual information generated by federated learning is that it is mostly 0 or a value close to 0. If the SBT quantization is used for information with the feature, such a method considers an attribute of data. Such a quantization scheme is used to increase redundancy of data, which may result in enhanced compression rates. However, high redundancy means great data loss, which leads to performance degradation. Thus, as an elemental technology for supporting the above-described NNC standard, the present disclosure proposes a new parameter quantization scheme capable of minimizing performance degradation for residual information generated by federated learning. Specifically, the present disclosure proposes a method that sets a degree of importance of each parameter based on a predefined threshold through a standard normal distribution and then uses different quantization schemes according to each degree of importance, thereby preventing deep learning performance degradation caused by compression of residual information generated by federated learning. The method will be described in detail below with reference to FIG. 6 to FIG. 15.

In addition, the entropy coding module 130 is a technique capable of enhancing compression efficiency through an entropy coding method that replaces similar values by one uniform value. For example, the entropy coding technique is a compression technique that allocates a different number of bits according to an occurrence probability of a value and thus expresses identical information in a smaller number of bits. For example, the Context Adaptive Binary Arithmetic Coding for Deep neural network compression (DeepCABAC) may be applied. Accordingly, information (e.g., residual information), which has undergone the quantization, is ultimately compressed into a bitstream through the entropy coding module and then is transmitted.

In addition, the NNC decoding apparatus 200 may be configured by including two basic modules. That is, the NNC decoding apparatus 200 includes an entropy decoding module 210 and a parameter inverse-quantization module 220.

Herein, the entropy decoding module 210 means a process of decoding a bitstream that has been encoded by the above-described entropy coding module 130. In addition, the parameter inverse-quantization module 220 means an inverse-quantization process that generates reconstructed residual information by reconstructing information (e.g., residual information) quantized by the above-described parameter quantization module 120.

FIG. 6 is a view for describing a process of a quantization scheme based on a standard normal distribution for a residual weight in federated learning according to an embodiment of the present disclosure. For example, the process of FIG. 6 may be performed by the above-described parameter quantization module 120 of FIG. 5.

Referring to FIG. 6, according to an embodiment of the present disclosure, a method for encoding a deep learning network by using a quantization scheme based on a standard normal distribution includes quantizing a residual parameter by using the parameter quantization module 120 and performing entropy encoding for the quantized residual parameter through the entropy coding module 130. Herein, the quantizing of the residual parameter determines a degree of importance of the residual parameter based on a predefined threshold by using the standard normal distribution and then selectively applies any one or more of a plurality of quantization schemes based on the determined degree of importance.

In addition, according to an embodiment of the present disclosure, the quantizing of the residual parameter includes determining a binary flag for selecting a quantization scheme by using a mean and a standard deviation of the residual parameter and determining the degree of importance of the residual parameter from the standard normal distribution and quantizing the residual parameter by applying any one of the pruning quantization scheme, the binary quantization scheme, the ternary quantization scheme or the additive exponent quantization scheme or a combination thereof using the determined degree of importance and the binary flag.

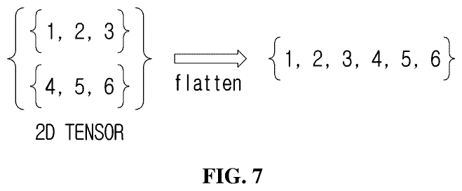

For example, the process of FIG. 6 may be additionally described as follows. First, residual information generated by federated learning is received as input (S1110). Herein, the residual information may be a residual weight and may also be referred to as a residual parameter. Herein, because the input residual information has a multidimensional tensor form, it is flattened to one dimension through dimension flattening in each layer (S1120). In addition, a probability density function is obtained for data of each layer and the probability density function is calculated for each layer to obtain a normal distribution (S1130), and thus whether a binary flag (binary_flag) is true or false is determined based on the normal distribution (S1140). Next, the normal distribution is transformed into a standard normal distribution (S1150), and at least one or more of three types of quantization schemes or a combination thereof is used based on a position in the standard normal distribution. In this regard, the quantization schemes proposed by the present disclosure include pruning quantization (S1160), binary-ternary quantization (S1170) and additive exponent quantization (S1180). Herein, the binary-ternary quantization (S1170) includes a binary quantization scheme (S1171) and a ternary quantization scheme (S1172). Hereinafter, each of the processes of FIG. 6 will be described in detail with reference to FIG. 7 to FIG. 15.

FIG. 7 is a view for describing a dimension flattening process (S1120) according to an embodiment of the present disclosure. Herein, the dimensional flattening process means a process of changing a multidimensional tensor to a 1D tensor to handle data more easily. As exemplified in FIG. 7, when a probability density function for one layer is obtained, 1D data may be more convenient to use than data constructed with 2D tensors with respect to data processing.

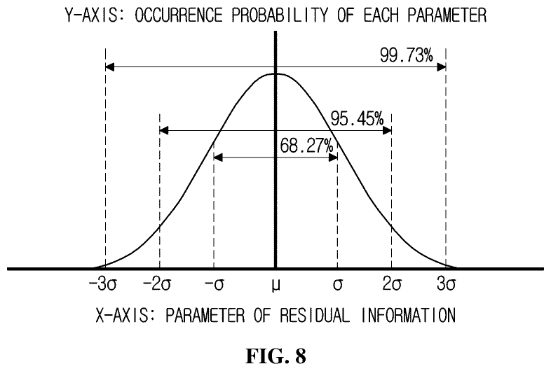

FIG. 8 is a view for describing a normal distribution using calculation of a probability density function for each layer (S1130) according to an embodiment of the present disclosure. The probability density function of a normal distribution may be formulated by Equation 1, and FIG. 8 shows the probability density function of a normal distribution.

$$f ( x ) = \frac{1}{σ \sqrt{2 π}} {e}^{- \frac{{( x - μ )}^{2}}{2 {σ}^{2}}} \qquad [ Equation 1 ]$$

Here, μ means a weighted mean of a corresponding layer, σ² means a weighted variance, and σ means a weighted standard deviation. Referring to FIG. 4 described above, a distribution chart of residual information has a form of normal distribution, and because there are a lot of samples, a normal distribution may be assumed and expressed by Equation 1. For example, it may be known experimentally that a probability within the first weighted standard deviation interval (−σ~σ) reaches 68.27%, a probability within the second weighted standard deviation interval (−2σ~2σ) reaches 95.45%, and a probability within the third weighted standard deviation interval (−3σ~3σ) reaches 99.73%. This is used for transformation into a standard normal distribution to be described below, and a weighted mean and a standard deviation, which are derived to obtain a probability density function of a normal distribution, may be used to determine whether a binary flag (binary_flag) is true or false.

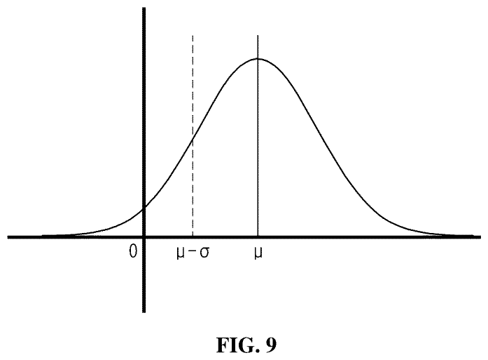

FIG. 9 is a view for describing per-layer binary flag setting (S1140) according to an embodiment of the present disclosure and visually exemplifies a criterion for determining whether or not the binary flag is true or false. The binary flag is a criterion for selecting, among the above-described quantization schemes, binary quantization (S1171) or ternary quantization (S1172) in the binary-ternary quantization process (S1170). Generally, residual information may be illustrated by a normal distribution centered at zero. That is, there may be an exceptional case in which a mean is not 0 but a specific positive value or negative value. In such a case, as illustrated in FIG. 9, if the absolute value of a difference between a mean and a standard deviation is greater than 0, the binary flag is set to true. This is because values with the opposite sign to the mean are determined to be of low importance, and an uniform sign is intended for subsequent binary quantization.

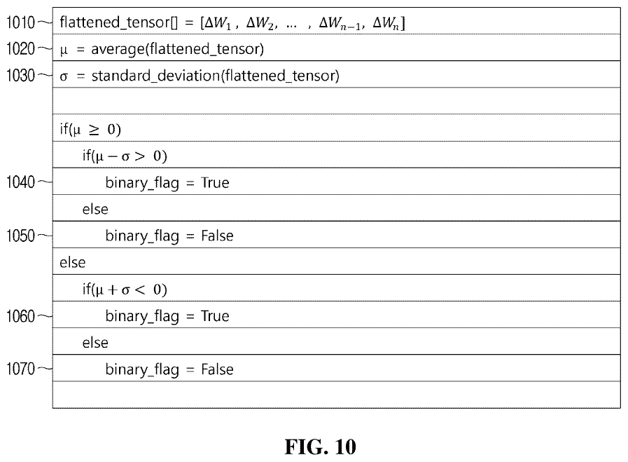

FIG. 10 is a view for describing a process of determining whether the binary flag is true or false, according to an embodiment of the present disclosure. For example, FIG. 10 represents the description of FIG. 9 by a pseudocode.

For example, ΔW₁~ΔWₙ are weight values of one layer of residual information and have been flattened and are stored in 1D tensor (1010). Next, a mean 1020 and a standard deviation 1030 of ΔW₁~ΔWₙ are derived during a process of obtaining the above-described probability density function of normal distribution. For example, when the mean is a positive value, if a difference value between the mean and the standard deviation is positive, the binary flag is true (1040), and if the difference value is negative, the binary flag is false (1050). On the other hand, when the mean is a negative value, if a sum of the mean and the standard deviation is smaller than 0, the binary flag is true (1060), and if the sum is greater than 0, the binary flag is false (1070).

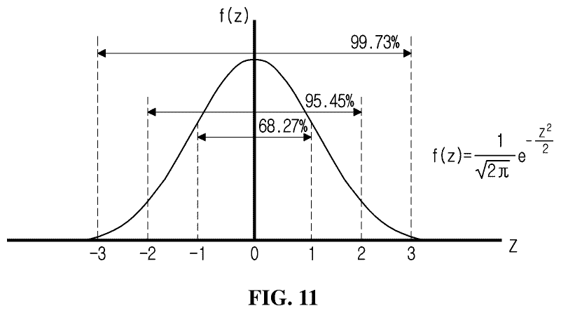

FIG. 11 is a view for describing the step of transforming a standard normal distribution (S1150) according to an embodiment of the present disclosure. A standard normal distribution is a standardized normal distribution, that is, a normal distribution with a mean of 0 and a standard deviation of 1. A normal distribution is standardized to a standard normal distribution for convenience of calculation. For example, a probability density function of a normal distribution uses a mean and a deviation to obtain an occurrence probability of a specific value, while a probability density function of a standard normal distribution is capable of obtaining an occurrence probability through z, as shown in FIG. 11.

The above-described standard normal distribution is advantageous in that a degree of importance of a weight may be calculated by considering the magnitudes and occurrence probabilities of weights of residual information simultaneously and then a threshold of quantization may be set more easily.

For example, a formula for obtaining a probability density function of a standard normal distribution may be expressed by Equation 2, in which input data of x is normalized to z through Equation 3.

$$f ( z ) = \frac{1}{\sqrt{2 π}} {e}^{- \frac{{z}^{2}}{2}} \qquad [ Equation 2 ]$$

$$z = \frac{x - μ}{σ} \qquad [ Equation 3 ]$$

For example, referring to the above-described case of FIG. 8, it may be known that a probability within a first standard normal distribution interval (−1~1) reaches 68.27%, a probability within a second standard normal distribution interval (−2~2) reaches 95.457%, and a probability within a third standard normal distribution interval (−3~3) reaches 99.73%.

In this regard, quantization schemes proposed by the present disclosure and using the binary flag and standard normal distribution include pruning quantization (S1160), binary-ternary quantization (S1170) and additive exponent quantization (S1180). That is, the pruning quantization (S1160) may be used for data with a lowest degree of importance. On the other hand, data, which is determined to have a higher degree of importance, is quantized through the binary-ternary quantization (S1170), and values with a highest degree of importance may be quantized to keep as close as possible to the original through the additive exponent quantization (S1180). Accordingly, by keeping a parameter with a high degree of importance as close as possible to an original value, performance degradation may be minimized in compressing residual information generated by federated learning. Hereinafter, the quantization schemes will be described in detail.

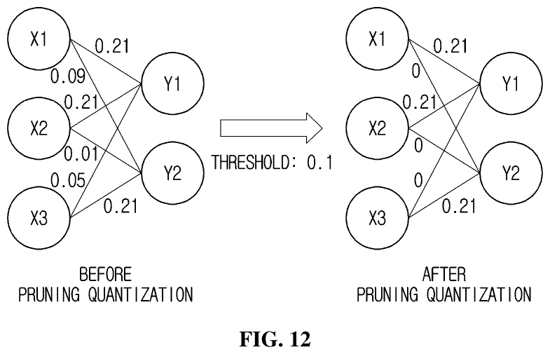

First, FIG. 12 is a view for describing the pruning quantization (S1160) according to an embodiment of the present disclosure. The pruning quantization scheme may be used as a quantization scheme performed for residual information with a lowest degree of importance according to an embodiment of the present disclosure. For example, in the above-described standard normal distribution of step S1150, if the absolute value of z is smaller than a specific threshold (e.g., 1, 0.1, etc.), every corresponding value may be replaced by 0. It is because values, of which z has an absolute value smaller than the threshold, have a high occurrence frequency but may be defined by a low importance value, meaning no significant impact on the performance of a model. The pruning quantization scheme may cause some data losses by replacing values with a high frequency by 0, but redundancy increases to that extent, which enables a high compression rate to be achieved in an entropy coding process. For example, referring to the example of FIG. 12, when residual weights prior to the pruning quantization include 0.21, 0.09 and 0.05 respectively, if the pruning quantization scheme is applied with the threshold set to 0.1, quantized residual weights are only 0.21 and 0.

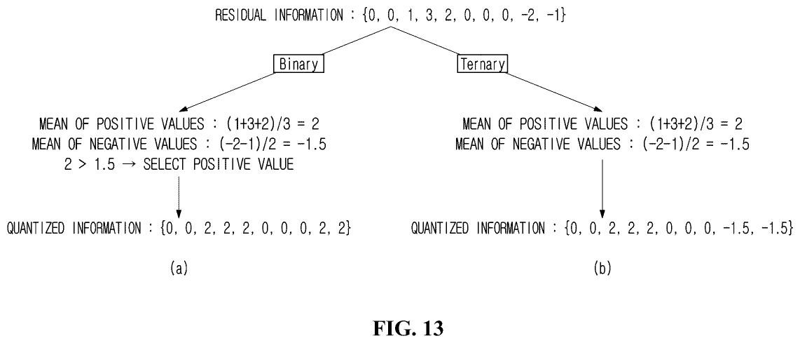

FIG. 13 is a view for describing the binary-ternary quantization (S1170) according to an embodiment of the present disclosure. According to an embodiment of the present disclosure, the binary-ternary quantization scheme may be used as a quantization technique for a case in which the absolute value of z in the standard normal distribution is within a specific interval (e.g., between 1 and 2). This is based on the same concept of the stochastic binary-ternary quantization (SBT quantization), which is one of the existing quantization schemes of NNC Standard, but the difference lies in that a criterion for selecting binary quantization or ternary quantization is determined not by the conventional Bernoulli distribution-based randomness but by the binary flag set in the above-described step S1140. That is, according to an embodiment of the present disclosure, if the binary flag is true, the binary quantization (S1171) may be selected, and if the binary flag is false, the ternary quantization (S1172) may be selected.

For example, (a) of FIG. 13 illustrates a simple example of the binary quantization scheme, and (b) of FIG. 13 illustrates a simple example of the ternary quantization scheme.

In this regard, the binary quantization scheme (S1171) is a quantization scheme that compares a mean of positive values and a mean of negative values and retains only a feature of a more influential sign. For example, a sign with a lager mean is more influential, and an opposite sign becomes 0. That is, values having a sign with a larger mean are replaced by the mean of the sign, and thus redundancy may be increased. For example, according to the example (a) of FIG. 13, if residual information is assumed to be {0,0,1,3,2,0,0,0,−2,−1}, the mean of the positive values is 2, and the mean of the negative values is −1.5. Therefore, because 2 is greater than 1.5 that is the absolute value of −1.5, the positive values are interpreted to be more influential than the negative values, and all the negative values are set to 0 accordingly. That is, the positive values of 1 and 3 are replaced by the mean value of 2, and the tensor composed of the values of −2,−1, 0, 1, 2 and 3 is quantized to a tensor composed only of 0 and 2, that is, {0,0,2,2,2,0,0,0,2,2}. Thus, the redundancy of 0 and 2 increases.

In the ternary quantization scheme (S1172), according to the example (b) of FIG. 13, if residual information is assumed to be {0,0,1,3,2,0,0,0,−2,−1}, a mean of each sign (each of positive and negative signs) is obtained. Then, a positive weight is replaced by the mean of the positive sign, and a negative weight is replaced by the mean of the negative sign. That is, while the above-described binary quantization scheme retains only one sign, the ternary quantization scheme retains both signs and thus reduces the loss of data. For example, as exemplified by (b) of FIG. 13, the positive values become 2, which is a positive mean, and the negative values become −1.5, which is a negative mean. As a result, the values may be quantized into {0,0,2,2,2,0,0,0,−1.5,−1.5}. Thus, more features may be retained by utilizing a further value (e.g. ‘−1.5’) as compared to the above-described binary quantization scheme.

The above-described binary quantization (S1171) and ternary quantization (S1172) do not cause as much data loss as the above-described pruning quantization scheme of FIG. 12. However, a certain level of data loss is unavoidable because various values are replaced by one mean value. However, in an embodiment of the present disclosure, because of the advantage that a layer subject to quantization can retain a minimal feature, the binary quantization scheme (S1171) or the ternary quantization scheme (S1172) is selectively applied for values with the absolute value of z being within a specific interval (e.g., between 1 and 2) in a standard normal distribution. That is, it is assumed that such weights with a degree of importance being neither relatively low nor high may retain a minimal feature, and the above-described binary quantization scheme (S1171) and/or the above-described ternary quantization scheme (S1172) is selectively performed.

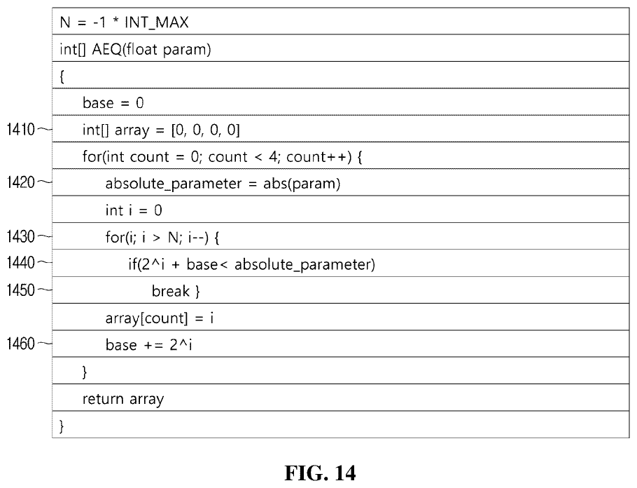

FIG. 14 is a view for describing the additive exponent quantization scheme (S1180) according to an embodiment of the present disclosure. For example, according to an embodiment of the present disclosure, it may be a quantization scheme applied to values, of which z has an absolute value greater than a specific threshold (e.g., 2) in the standard normal distribution of step S1150 described above. That is, the additive exponent quantization (S1180) is a quantization scheme capable of retaining values as close as possible to the original by using a small number of bits.

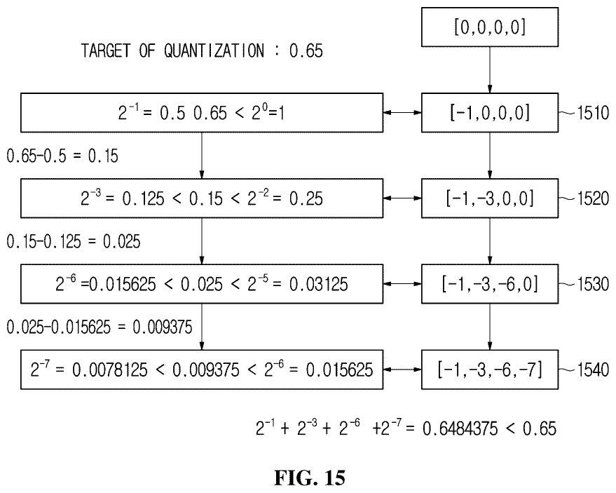

For example, FIG. 14 represents the process of additive exponent quantization (S1180) by a pseudocode. First, an array with N elements (e.g., 4 elements) is initialized (1410). Next, 2 to the power of i is calculated, starting from i=0 (1420). Next, i is decreased until it becomes smaller than a value to be quantized (1430). For example, when i becomes smaller than a parameter to be quantized (1440), i stops decreasing (1450), and 2 to the power of i at the moment is taken as a baseline (1460). The above process is performed again from the baseline, and after the process is performed a total of N times (e.g., 4 times), i determined in each loop statement is input as an element of the pre-initialized array. For example, the process may be described with reference to FIG. 15 as follows.

FIG. 15 is a view illustrating a specific example of the additive exponent quantization (S1180) according to an embodiment of the present disclosure. For example, FIG. 15 is an example illustrating a process of quantizing the value of 0.65 through the additive exponent quantization scheme (S1180).

Referring to FIG. 15, first, if i=0, 2ⁱ is 1. Because 1 is greater than 0.65, i is decreased to −1. As 2⁻¹ is 0.5 and 0.5 is smaller than 0.65, 0.5 becomes a baseline, and −1 is inserted as a first element of an array (1510). Next, i is decreased until the addition of 2 to the power of i and 0.5 becomes smaller than 0.65. If i is −2, 0.5+2⁻² becomes 0.5+0.25, that is, 0.75. If i is decreased again, 0.5+2⁻³ is calculated as 0.5+0.125, that is, 0.625. Herein, because 0.625 is smaller than 0.65, 0.65 becomes a baseline, and −3 is inserted as a second element of the array (1520). When the above process is further performed twice, an 1D array of [−1,−3,−6,−7] may be ultimately obtained as illustrated in FIG. 15 (1540).

As a result, from the example of FIG. 15, 0.65 is approximated to a very close value of 0.6484375. 0.65 seems to require a less number of bits than the approximated result value (0.6484375). However, considering all parameters, a method of representing an array of integers according to the additive exponent quantization scheme (S1180) may increase redundancy and thus achieve a high compression rate in entropy coding. In addition, because the additive exponent quantization scheme (S1180) may restore a very close value to an original parameter, it may be used as a suitable quantization scheme for weights with a high degree of importance. Accordingly, the additive exponent quantization scheme may be more efficiently applied to a parameter, which is determined to have a high degree of importance, for example, a parameter of which z has an absolute equal to or greater than 2 in the standard normal distribution of the above-described step S1150.

If the above-described processes of FIG. 6 to FIG. 15 are summarized, according to an embodiment of the present disclosure, after a parameter of input residual information is transformed into the standard normal distribution, different quantization schemes are used according to a range of z. For example, if the absolute value of z is smaller than 1, the parameter is determined to have a low degree of importance and is replaced by 0 through the pruning quantization (S1160). On the other hand, for a parameter which has a z value between 1 and 2 in the standard normal distribution, the binary quantization (S1171) or the ternary quantization (S1172) is performed because they can retain a minimal feature. Finally, a parameter, which is determined to have a highest degree of importance, that is, of which a z value is equal to or greater than 2, is quantized by using the additive exponent quantization (S1180). A high compression rate and low performance degradation may be ensured by using all the three types of quantization schemes proposed by the present disclosure or by combining some of the quantization schemes.

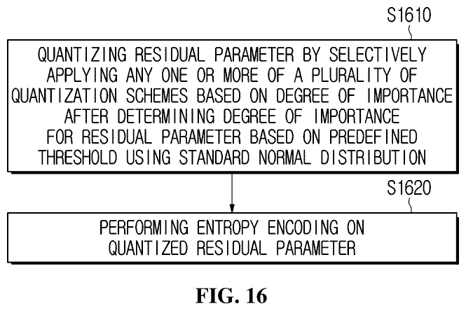

FIG. 16 illustrates a method for encoding a deep learning network by using a quantization scheme based on a standard normal distribution according to an embodiment of the present disclosure. The method for encoding a deep learning network may include quantizing a residual parameter (S1610) by selectively applying any one or more of a plurality of quantization schemes based on a degree of importance after determining the degree of importance for the residual parameter based on a predefined threshold using a standard normal distribution and performing entropy coding on the quantized residual parameter (S1620).

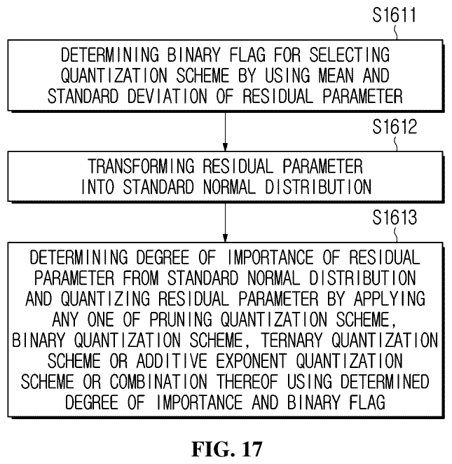

FIG. 17 illustrates detailed steps of the above-described quantizing of the residual parameter (S1610) of FIG. 16. That is, the quantizing of the residual parameter (S1610) includes determining a binary flag for selecting a quantization scheme by using a mean and a standard deviation of the residual parameter (S1611), transforming the residual parameter into a standard normal distribution (S1612), and determining the degree of importance of the residual parameter from the standard normal distribution and quantizing the residual parameter by applying any one of the pruning quantization scheme, the binary quantization scheme, the ternary quantization scheme or the additive exponent quantization scheme or a combination thereof using the determined degree of importance and the binary flag (S1613).

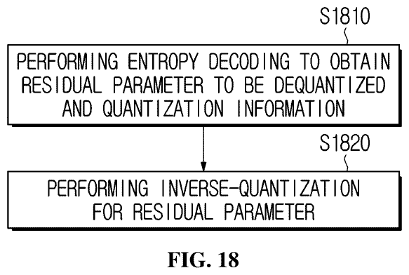

FIG. 18 illustrates a method for decoding a deep learning network encoded by a quantization scheme based on a standard normal distribution according to an embodiment of the present disclosure. The method for decoding a deep learning network includes performing entropy decoding to obtain a residual parameter to be dequantized and quantization information (S1810) and performing inverse-quantization for the residual parameter (S1820).

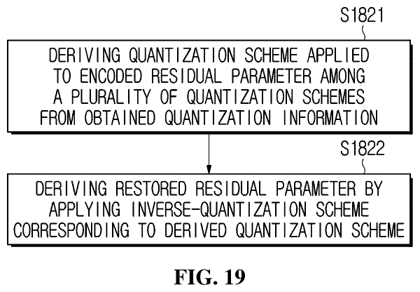

FIG. 19 illustrates detailed steps of the above-described performing of the inverse-quantization (S1820) of FIG. 18. The performing of the inverse-quantization (S1820) includes deriving a quantization scheme applied to an encoded residual parameter among a plurality of quantization schemes from the obtained quantization information (S1821) and deriving a restored residual parameter by applying an inverse-quantization scheme corresponding to the derived quantization scheme (S1822). Herein, according to an embodiment of the present disclosure, the plurality of quantization schemes include a pruning quantization scheme, a binary quantization scheme, a ternary quantization scheme, and an additive exponent quantization scheme.

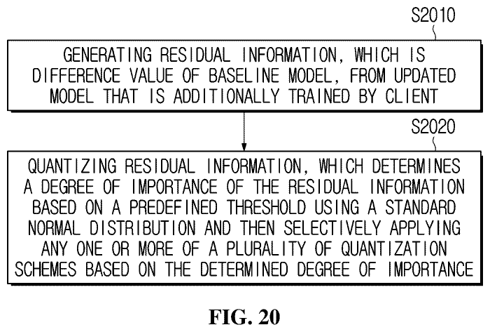

FIG. 20 illustrates a deep learning network encoding method that performs federated learning through a plurality of clients according to an embodiment of the present disclosure. The deep learning network encoding method includes generating residual information, which is a difference value of a baseline model, from an updated model that is additionally trained by a client (S2010) and quantizing the residual information (S2020). The quantizing of the residual information determines a degree of importance of the residual information based on a predefined threshold using a standard normal distribution and then selectively applying any one or more of a plurality of quantization schemes based on the determined degree of importance.

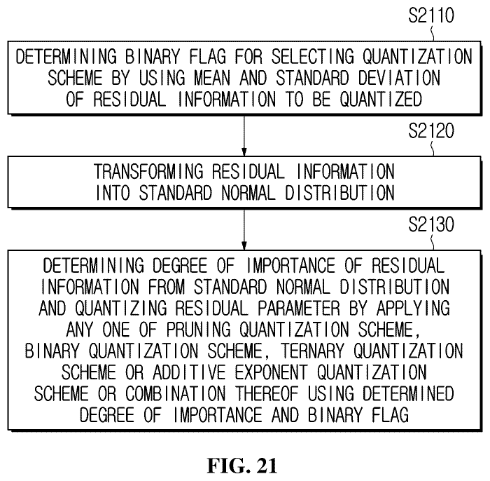

FIG. 21 illustrates a quantization method for encoding a deep learning network according to an embodiment of the present disclosure. The quantization method includes determining a binary flag for selecting a quantization scheme by using a mean and a standard deviation of residual information to be quantized (S2110), transforming the residual information into a standard normal distribution (S2120), and determining a degree of importance of the residual information from the standard normal distribution and quantizing the residual parameter by applying any one of the pruning quantization scheme, the binary quantization scheme, the ternary quantization scheme or the additive exponent quantization scheme or a combination thereof using the determined degree of importance and the binary flag (S2130).

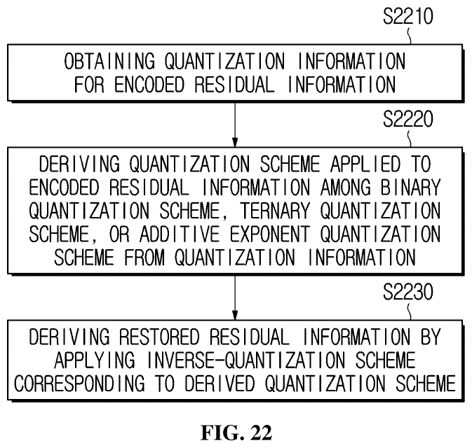

FIG. 22 illustrates an inverse quantization method for decoding a deep learning network according to an embodiment of the present disclosure. The inverse-quantization method includes obtaining quantization information for encoded residual information (S2210), deriving a quantization scheme applied to the encoded residual information among the binary quantization scheme, the ternary quantization scheme, or the additive exponent quantization scheme from the quantization information (S2220), and deriving restored residual information by applying an inverse-quantization scheme corresponding to the derived quantization scheme (S2230).

Although exemplary methods of the present disclosure are represented as a series of operations for clarity of description, the order of the steps is not limited thereto, and when necessary, the illustrated steps may be performed simultaneously or in a different order. In order to realize the method according to the present disclosure, other steps may be added to the illustrative steps, some steps may be excluded while the remaining steps may be included, or some steps may be excluded while additional steps may be included.

In the present disclosure, an encoding apparatus or a decoding apparatus performing a predetermined operation (step) may perform an operation (step) for checking a condition or situation for performing the predetermined operation (step). For example, in case it is specified that a predetermined operation is not performed unless a predetermined condition is satisfied, an encoding apparatus or a decoding apparatus may perform the predetermined operation after performing an operation for checking whether or not the predetermined condition is satisfied.

The various embodiments of the present disclosure are not intended to list all possible combinations, but to illustrate representative aspects of the present disclosure. The matters described in the various embodiments may be applied independently or in a combination of two or more.

Also, the various embodiments of the present disclosure may be implemented by hardware, firmware, software, or a combination thereof. With hardware implementation, the embodiment may be implemented by using at least one selected from a group of application specific integrated circuits (ASICs), digital signal processors (DSPs), digital signal processing devices (DSPDs), programmable logic devices (PLDs), field programmable gate arrays (FPGAs) general-purpose processors, controllers, micro controllers, micro processors, etc.

Furthermore, a decoding apparatus and an encoding apparatus, to which the present disclosure is applied, may be included in a multimedia broadcasting transmission and reception device, a mobile communication terminal, a home cinema video device, a digital cinema video device, a camera for monitoring, a video dialog device, a real-time communication device such as video communication, a mobile streaming device, a storage medium, a camcorder, a video on-demand (VOD) service provision device, an over the top (OTT) video device, an Internet streaming service provision device, a three-dimensional (3D) video device, a video telephony device, and a medical video device, and may be used to process a video signal or a data signal. For example, the OTT video device may include a game console, a Blu-ray player, Internet access TV, a home theater system, a smartphone, a tablet PC, and a digital video recorder (DVR).

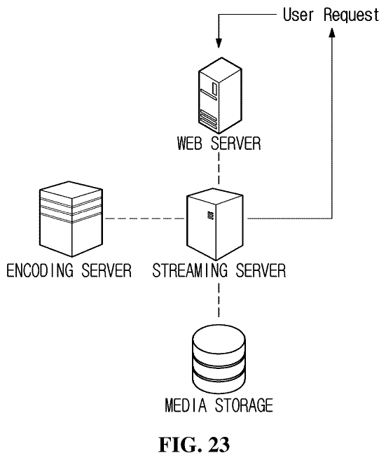

FIG. 23 is a view exemplifying a content streaming system to which an embodiment according to the present disclosure is applicable. As illustrated in FIG. 23, the content streaming system, to which an embodiment of the present disclosure is applied, may largely include an encoding server, a streaming server, a web server, a media storage, a user device, and a multimedia input device.

The encoding server may compress the content input from multimedia input devices such as a smartphone, a camera and CCTV into digital data to generate a bitstream and transmit it to the streaming server. As another example, when the multimedia input devices such as the smartphone, the camera and the CCTV generate a bitstream on their own, the encoding server may be omitted.

The bitstream may be generated by an encoding method and/or an encoding apparatus, to which an embodiment of the present disclosure is applied, and the streaming server may temporarily store the bitstream in the process of transmitting or receiving the bitstream.

The streaming server transmits multimedia data to the user device based on a user request through the web server, and the web server serves as an intermediary to inform the user of what service is present. When a user requests a desired service to the web server, the web server delivers it to the streaming server, and the streaming server may transmit multimedia data to the user. At this time, the content streaming system may include a separate control server, in which case the control server serves to control commands/responses between devices in the content streaming system.

The streaming server may receive contents from the media storage and/or the encoding server. For example, when the streaming server receives contents from the encoding server, the streaming server may the contents in real time. In this case, to provide a smooth streaming service, the streaming server may store the bitstream for a predetermined time.

Examples of the user devices include mobile phones, smartphones, laptop computers, digital broadcasting terminals, PDAs (personal digital assistants), PMPs (portable multimedia players), navigation devices, slate PCs, tablet PCs, ultrabooks, wearable devices (such as smartwatch-type devices, smart glasses-type devices, head-mounted displays (HMDs)), digital TVs, desktop computers, and digital signage, among others.

Each server in the content streaming system may operate as a distributed server, in which case the data received by each server may be processed in a distributed manner.

The scope of the present disclosure includes software or machine-executable instructions (such as operating systems, applications, firmware, programs, etc.) that cause operations according to various embodiments to be executed on a device or computer, and non-transitory computer-readable media on which such software or instructions are stored and can be executed on the device or computer.

### INDUSTRIAL APPLICABILITY

According to embodiments of the present disclosure, the present disclosure may be utilized for encoding or decoding a deep learning network.

1. A method for encoding a deep learning network by using a quantization scheme based on a standard normal distribution, the method comprising:
quantizing a residual parameter; and
performing entropy encoding on the quantized residual parameter,
wherein the quantizing of the residual parameter determines a degree of importance of the residual parameter based on a predefined threshold by using the standard normal distribution and selectively applies any one or more of a plurality of quantization schemes based on the determined degree of importance.

2. The method of claim 1, wherein the quantizing of the residual parameter comprises:
determining a binary flag for selecting a quantization scheme by using a mean and a standard deviation of the residual parameter;
transforming the residual parameter into a standard normal distribution; and
determining the degree of importance of the residual parameter from the standard normal distribution and quantizing the residual parameter by applying any one of a pruning quantization scheme, a binary quantization scheme, a ternary quantization scheme or an additive exponent quantization scheme, or a combination thereof and by using the determined degree of importance and the binary flag.

3. The method of claim 2, wherein the residual parameter is a residual weight of the deep learning network, which is generated by federated learning.

4. The method of claim 2, wherein the quantizing of the residual parameter further comprises flattening a dimension of a residual parameter to be quantized, and
wherein a changed dimension of the residual parameter is derived as one dimension.

5. The method of claim 2, wherein the pruning quantization scheme is selected when an absolute of a value (z) normalized by the standard normal distribution is smaller than a preset first threshold.

6. The method of claim 5, wherein the preset first threshold is 1.

7. The method of claim 6, wherein the pruning quantization scheme replaces every residual parameter, to which the pruning quantization scheme is applied, by 0.

8. The method of claim 2, wherein any one of the binary quantization scheme or the ternary quantization scheme is selected when the absolute value of the value (z) normalized by the standard normal distribution is within a specific preset interval.

9. The method of claim 8, wherein the specific preset interval is an interval between 1 and 2.

10. The method of claim 8, wherein the quantizing of the residual parameter further comprises calculating a probability density function for each layer of the deep learning network,
wherein the binary flag for selecting one from the binary quantization or the ternary quantization scheme is determined by obtaining a mean and a standard deviation from a normal distribution of the probability density function.

11. The method of claim 10, wherein, when a difference between the mean and the standard deviation of the residual parameter has an absolute value greater than 0, the binary flag is set to true and the binary quantization scheme is selected.

12. The method of claim 10, wherein, when the difference between the mean and the standard deviation of the residual parameter has an absolute value smaller than 0, the binary flag is set to false and the ternary quantization scheme is selected.

13. The method of claim 2, wherein the additive exponent quantization scheme is selected when the absolute of the value (z) normalized by the standard normal distribution is greater than a preset second threshold.

14. The method of claim 13, wherein the preset second threshold is 2.

15. A method for decoding a deep learning network that is encoded by a quantization scheme based on a standard normal distribution, the method comprising:
performing entropy decoding to obtain a residual parameter to be dequantized and quantization information; and
performing inverse-quantization to dequantize the residual parameter,
wherein the performing of the inverse-quantization comprises deriving a quantization scheme applied to an encoded residual parameter among a plurality of quantization schemes from the obtained quantization information and deriving a restored residual parameter by applying an inverse-quantization scheme corresponding to the derived quantization scheme.

16. The method of claim 15, wherein the plurality of quantization schemes include a pruning quantization scheme, a binary quantization scheme, a ternary quantization scheme, and an additive exponent quantization scheme.

17. A method for encoding a deep learning network performing federated learning through a plurality of clients, the method comprising:
generating residual information, which is a difference value of a baseline model, from an updated model that is additionally trained by the clients; and
quantizing the residual information,
wherein the quantizing of the residual information determines a degree of importance of the residual information based on a predefined threshold by using a standard normal distribution and then selectively applies any one or more of a plurality of quantization schemes based on the determined degree of importance.

18. (canceled)

19. (canceled)

20. (canceled)
